(19) United States
(12) Patent Application Publication
(10) Pub. No.: US 2019/0008324 A1
(43) Pub. Date: Jan. 10, 2019

(54) Heated and heating serving plate

(71) Applicant: Dario D'Ottavio, Selvazzano (PD) (IT)

(72) Inventor: Dario D'Ottavio, Selvazzano (PD) (IT)

(21) Appl. No.: 15/748,774

(22) PCT Filed: Jul. 26, 2016
(86) PCT No.: PCT/IB2016/054447

§ 371 Date: Jan. 30, 2018

(30) Foreign Application Priority Data
Aug. 7, 2015 (IT) 102015000043511

(51) Int. Cl. A47J 39/00; A47J 36/24

(52) U.S. Cl. CPC A47J 39/006; A47J 36/2483

(57) ABSTRACT

A warming tray includes an upper plate, on which food or a dish containing the food can be placed, and which is adapted to be coupled with a lower plate that includes an upper side adapted to accommodate the upper plate and a lower plate, the upper and lower sides being joined by a perimeter wall. The lower plate includes one or more heating resistances, a thermostat, one or more electric energy accumulators, a charge regulator, a discharge regulator, an on/off switch, and a recharge connector. Turning the switch on or off supplies power to the thermostat and to the heating resistances, which provide for heating the upper side of the lower plate and the upper plate.

The present patent relates to warming trays and in particular concerns a new warming tray to heat and keep food warm.

Some dishes are served warm and must be kept so while the dish is being eaten or until the user stops eating or enjoying it.

Currently, to keep dishes warm the plates with which they are served are preheated, in some cases the food is kept warm with small candles placed under the plate.

In the case of takeaway pizzas, pizzas are transported in cardboard boxes to their destination for consumption.

The cardboard boxes for takeaway pizzas limit the cooling of the pizzas contained therein but they do not completely prevent the cooling of the pizzas themselves. Some people move the pizza from the cardboard box to a ceramic plate to eat it.

The pizza cools rapidly because the ceramic plate is initially at room temperature and absorbs the heat from the pizza.

Some people preheat the ceramic plate before using it, but this operation uses a significant amount of energy without really knowing if it the plate is too hot or too cool.

Other people eat the pizza directly from the cardboard box. The pizza cools quickly because the cardboard bottom of the box absorbs heat from the pizza and transfers it to the table on which the box is laid.

To overcome all the above drawbacks a new heated warming tray was designed and constructed.

The purpose of the new warming tray is to maintain the temperature of the plate placed on it and the food contained in it.

Another purpose of the new warming tray is to heat the plate which is placed on it.

Yet another purpose of the new warming tray is to heat the plate and the food on it when placed on the warming tray.

A further purpose of the new warming tray is to maintain the temperature of solid non-greasy foods when placed on the warming tray whether directly or with the possible interposition of a metal plate.

Still another purpose of the new warming tray is to heat solid non-greasy foods when laid on the warming tray whether directly or with the possible interposition of a metal plate.

Another purpose of the new warming tray is to allow the adjustment of the heat in order to maintain or increase the temperature of foods.

Yet another purpose of the new warming tray is that it does not require external heat for its operation.

Still another purpose of the new warming tray is that it does not require any electrical connection during its use.

These and other purposes, direct and complementary, are achieved by the new warming tray to heat and maintain the temperature of food, comprising in its main parts at least one upper plate, one lower plate, one or more heating elements, a thermostat, one or more batteries, a charge regulator, an accumulator discharge regulator, an on/off switch, and a charging connector.

The upper plate comprises at least a first ring-shaped external part suited to enclose and contain a second central part.

In particular, the first ring-shaped part of the upper plate is made of heat insulating and electrically insulating material, for example plastic or wood or ceramic, while the second central part is made of a thermally conductive material.

The upper plate is in any case made of easily washable materials.

The lower plate comprises an upper and a lower side, generically round joined by a cylindrical peripheral wall which forms a casing suited to contain and enclose the other components of the new warming tray.

In particular the upper side of the lower plate is suited to hold the upper plate, and comprises an insulating peripheral edge, and a central heat conducting part.

The heating elements, whether one or more, have a suitable shape such as a ring, and are fastened and adherent to the lower side of the central part of the upper side of the lower plate.

This same lower side of the upper plate is equipped with a thermostat.

The thermostat has a lever or knob that can be operated through an opening or hole in the lower side of the lower plate or on the outer cylindrical wall.

One possible embodiment of the invention may provide for a partition inside the lower plate, located below and parallel to the upper side of the lower plate, so as to prevent the heat generated by the heating elements from being transferred to other parts underlying the new warming tray.

The lower plate, preferably on its cylindrical outer wall, is equipped with the aforementioned charging connector.

The on/off switch is placed in an easily accessible place, such as on the cylindrical outer wall of the lower plate or on the outer edge of the upper side of the lower plate.

The peripheral edge of the upper side of the lower plate is laterally inclined so as to facilitate access to the on/off switch and the view of the indication lights. An embodiment of the invention may include a recess on the edge of the upper plate or an edge with a smaller width so as to allow access to the on/off switch and enable the indication lights to be seen on the lower plate.

The batteries, the charge regulator, and the discharge regulator are located inside the lower plate.

The batteries are connected both to the charging connector by means of the charging regulator and the discharge regulator through the on/off switch.

The discharge regulator is connected, in turn, with the thermostat and the heating elements.

The batteries can be charged by supplying adequate power through the charging connector.

The on/off switch connects or disconnects the electric power supply to the thermostat and the heating elements.

When powered, the heating elements heat the upper side of the lower plate and the upper plate resting on the lower plate.

The thermostat continuously monitors the temperature of the upper side of the lower plate.

When the aforementioned central part of the upper side reaches the preset temperature, the thermostat interrupts the power supply to the heating elements and then re-establishes the power supply when the temperature of the central part begins to drop below the preset threshold.

The lower plate is equipped with indicator lights, installed for example on the cylindrical outer wall or on the outer edge of the upper side of the lower plate, in order to indicate if the accumulator is being charged, when the accumulator is fully charged, if the power is on, and whether the heating elements are operating or not.

The upper plate, as well as the upper part and the lower part of the lower plate may have, along the perimeter, in the areas outside the parts which are heated directly, electrical connection contacts with identical warming trays stacked above so as to enable the simultaneous charging of two or more stacked warming trays with a single warming tray connected to the mains.

In addition, the upper plate and lower plate may have connection and coupling elements suited to constrain the upper plate on the upper part of the lower plate in a correct position.

A possible embodiment may also have a cover, applicable and attachable to the upper plate or the upper part of the lower plate so as to create a heat chamber above the new warming tray, suited to keep the upper plate hot or prevent the cooling of the food on the upper plate or on the upper part of the lower plate. This cover may comprise electrical terminal contacts with identical warming trays placed above it so as to allow the simultaneous charging of two or more stacked warming trays with just one warming tray connected to the mains.

One possible embodiment may have two relays suited to provide current directly from the charging connector (Y) and/or from the electrical connecting contacts to the switch, to the thermostat, and the heating elements when the new warming tray is connected to the mains or is stacked with another warming tray connected to the mains, so as not to draw energy from the batteries, whether charged or being charged.

The following is a description of the operation of the new warming tray. The new warming tray, with charged batteries, is placed on a stable surface, such as a table.

A solid, non-greasy food, such as pizza or bread, or a heat-conducting plate with non-solid food, such as meat or soup, is placed on the upper plate of the new warming tray.

The on/off switch is activated so as to supply energy to the heating elements. The upper side of the lower plate, and the upper plate placed on it, are heated to the preset temperature by the thermostat, heating the food or the dish with the food placed on the upper plate.

Upon reaching the preset temperature the thermostat interrupts the power supply and then cyclically provides power to the heating elements so as to maintain the operating temperature of the upper side of the upper plate.

The new warming tray may also be turned on in advance until it reaches the operating temperature and then the food or the dish with the food may be placed on the preheated upper plate.

The characteristics of the new warming tray will be better clarified by the following description with reference to the drawings, attached by way of a non-limiting example.

In the attached drawing, by way of a non-limiting example, a practical embodiment of the invention is presented.

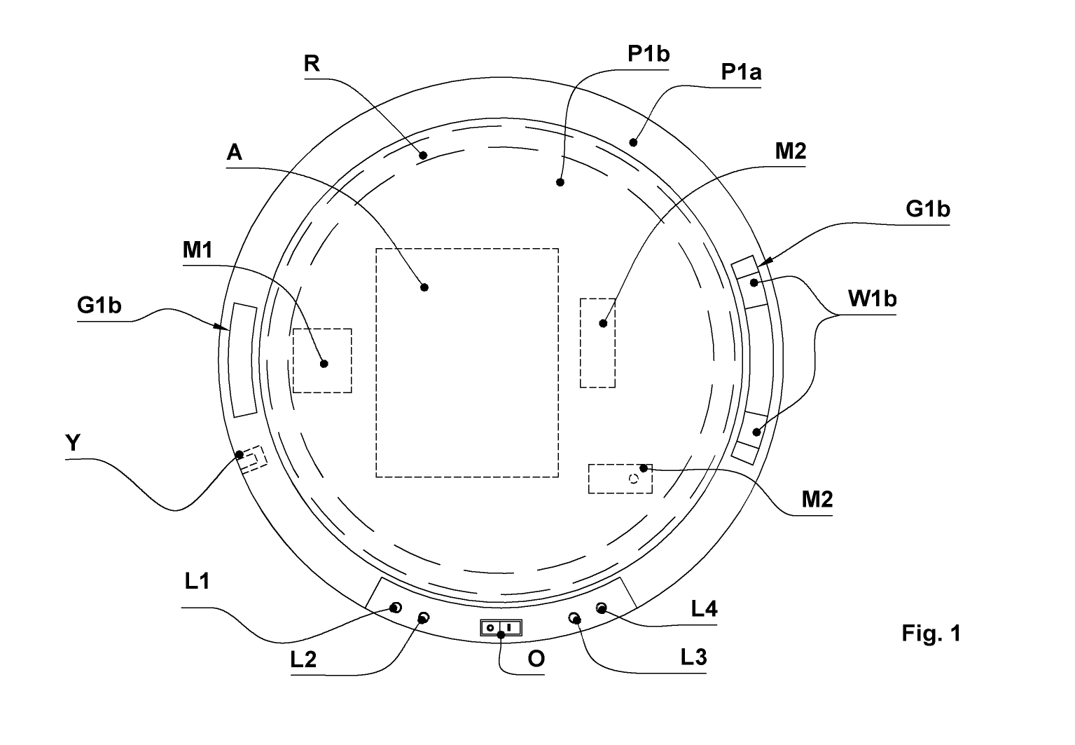

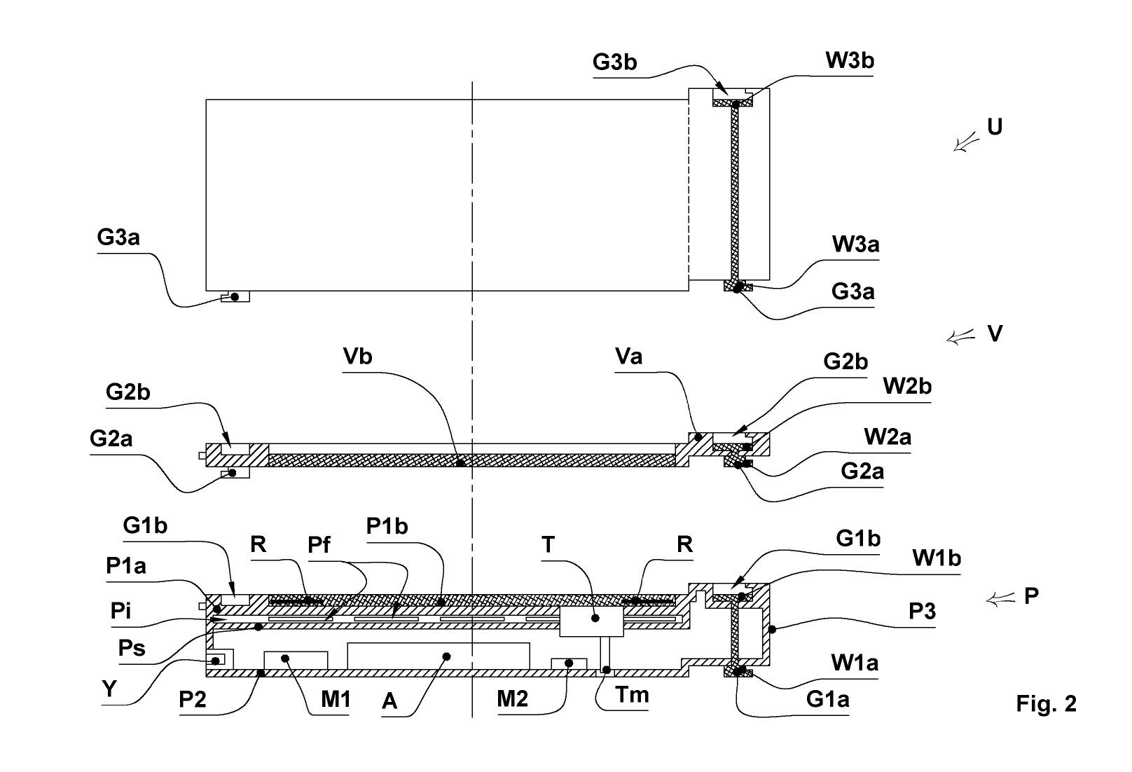

FIGS. 1 and 2 show respectively a top view and a vertical section of the new warming tray comprising an upper plate (V), a lower plate (P), one or more heating resistances (R), a thermostat (T), one or more batteries (A), a charge regulator (M1), a discharge regulator (M2), and a switch (O).

The upper plate (V) comprises at least one first external ring-shaped part (Va), made of heat insulating and electrically insulating material, suited to delimit and contain a second central part (Vb) made of heat conducting material.

The lower plate (P) comprises a generally circular upper side (P1a, P1b) and lower side (P2) joined by a cylindrical perimeter wall (P3), and constitutes a box-shaped casing suited to contain and enclose the other parts of the new warming tray.

In particular, the upper side (P1a, P1b) of the lower plate (P) is suited to accommodate the upper plate (V) and comprises a heat-insulating peripheral edge (P1a) and a central heat conductive part (P1b).

The heating resistances (R) are fastened and adhere to the lower surface of the central part (P1b) of the upper side (P1a, P1b) of the lower plate (P).

The thermostat (T) is located on the same lower surface of the upper side (P1a) and has a lever or control knob (Tm) accessible through an opening or hole present in the lower side (P2) of the lower plate (P).

Inside the lower plate (P) there is a partition (Ps), located below and parallel to the upper side (P1a, P1b) of the lower plate (P), so as to obtain an air space (Pi) between the upper side (P1a, P1b) and the inside of the lower plate (P).

Ventilation slits or openings (Pf) are located on the cylindrical perimeter wall (P3) of the lower plate (P) in correspondence with the air space (Pi) between the upper side (P1a, P1b) and the inside of the lower plate (P).

The charging connector (Y) is located on the cylindrical perimeter wall (P3) of the lower plate.

The on/off switch (O) and the four indicator lights or LEDs (L1, L2, L3, L4) are located on the outer heat-insulating perimeter edge (P1a) of the upper side (P1a, P1b) of the lower plate and indicate that the accumulator is currently charging (L1), the full charge state (L2) of the accumulator, the operation status (L3), and the status of the heating (L3) in progress.

In particular, the portion of the heat-insulating perimeter edge (P1a) of the upper side (P1a, P1b) in which the on/off switch (O) and the four indicator lights or LEDs (L1, L2, L3, L4) are located is laterally inclined so as to facilitate access to the on/off switch (O) and increase the visibility of the indicator lights (L1, L2, L3, L4).

The lower plate (P) contains the accumulator (A), the charge regulator (M1), and the discharge regulator (M2).

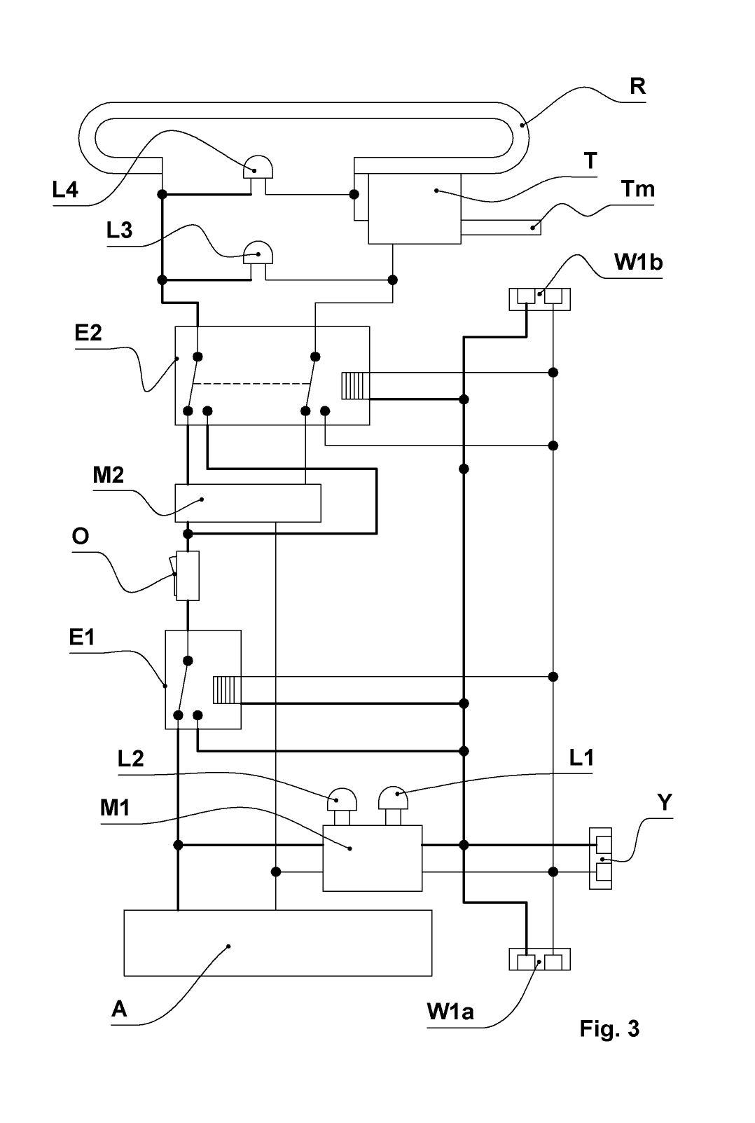

FIG. 3 shows a diagram of the electrical connection between the charging connector (Y), the charge regulator (M1), the batteries (A), the on/off switch (O), the discharge regulator (M2), the indicator lights or LED lamps (L1, L2, L3, L4), the thermal resistance (R), and the thermostat (T).

FIG. 2 shows the lid (U), attachable and connectable to the upper plate (V) or directly to the upper side (P1) of the lower plate (P) so as to create a thermal chamber suited to keep food warm or prevent it from cooling when placed on the upper plate (V) or the upper side (P1) of the lower plate (P).

The upper plate (V), the lower plate (P), and the lid (U) have coupling and connection elements (G1a, G1b, G2a, G2b, G3a, G3b) suited to keep the upper plates (V), lower plate (P), and lid (U) together in the correct position.

In the example shown in the figures, the coupling and connection elements (G1a, G1b; G2a, G2b, G3a, G3b) comprise contacts (W1A, W1b; W2a, W2b, W3a, W3b) connected to the charging connector (Y) so as to allow additional warming trays to be stacked, with or without a lid (U), and the batteries (A) of the new stacked warming trays to be recharged by connecting only one to the mains.

In the diagram in FIG. 3 there are two relays (E1, E2) suited to supply electric power directly from the charging connector (Y) or from the contacts (W1A, W1b) to the switch (O), the thermostat (T), and the thermal resistance (R) when the new warming tray is connected to the mains or is stacked with another warming tray connected to the mains so as not to draw energy from the accumulator (A), whether charged or charging.

Therefore, with reference to the preceding description and the attached drawings the following claims are made.

The invention claimed is:

1. A warming tray comprising:
at least one upper plate (V), adapted to receive food or a dish containing the food to be heated, and to be coupled with a lower plate (P),
wherein said lower plate (P) comprises an upper side (P1a, P1b) adapted to accommodate said upper plate (V) and a lower side (P2), said upper and lower sides being joined by a perimeter wall (P3),
wherein said lower plate (P) is adapted to house:
at least one heating resistance (R) fixed to or in contact with said upper side (P1a, P1b);
at least one thermostat (T) electrically connected to said heating resistance (R) and placed in contact with said upper side (P1a, P1b);
at least one accumulator of electric energy (A);
at least one recharge connector (Y) directly or indirectly connected to said accumulator of electric energy (A);
at least one on/off switch (O) interposed between said thermostat (T) and said accumulator of electric energy (A),
wherein operation of said on/off switch (O) provides power to said heating resistance (R) through said thermostat (T), and
wherein said thermostat (T) interrupts power supply to said heating resistance (T) when a temperature set on the thermostat (T) has been reached.

2. The warming tray according to claim 1,
wherein said upper side (P1a, P1b) of said lower plate (P) comprises a first external part (P1a) adapted to delimit and contain a second central part (P1b),
wherein said first part (P1a) of said upper side (P1a, P1b) is made of an insulating material, and
wherein said second central part (P1b) is made of a thermally conductive material.

3. The warming tray according to claim 1, wherein said lower plate (P) comprises a recharge connector (Y) directly or indirectly connected to said electric accumulator (A).

4. The warming tray according to claim 1, wherein said lower plate (P) comprises a first indicator light (L3) that indicates a state of the on/off switch (O) and a second indicator light (L4) that signals whether the heating resistance (R) is being powered/heated or not.

5. The warming tray according to claim 1, wherein said lower plate (P) comprises a charge regulator (M1) interposed between said accumulator of electric energy (A) and said recharge connector (Y), a first indicator light (L1) that signals that the accumulator (A) is being recharged and a second indicator light (L2) that signals that a recharge of said accumulator (A) has been completed, and wherein said charge regulator (M1) is adapted to regulate a recharge power supply of said accumulator (A).

6. The warming tray according to claim 1, wherein said lower plate (P) comprises a discharge regulator (M2) interposed between said on/off switch (O) and said heating resistance (R) and thermostat (T), adapted to interrupt the power supply to said heating resistance (R) and thermostat (T) when a charge of the accumulator (A) falls below a minimum level.

7. The warming tray according to claim 1, wherein said lower plate (P) comprises a partition (Ps) placed under and parallel to said upper side (P1a, P1b) of said lower plate (P) and providing an air space (Pi) between said upper side (P1a, P1b) and an inside of the lower plate (P), and wherein said perimeter wall (P3) of said lower plate (P) comprises ventilation slits or openings (Pf) at a level of said air space (Pi) between said upper side (P1) and the inside of said lower plate (P).

8. The warming tray according to claim 1, wherein said upper plate (V) and said lower plate (P) are provided with first coupling and connection elements (G1a, G1b; G2a, G2b) suited to maintain said upper plate (V) and said lower plate (P) joined together in a correct position.

9. The warming tray according to claim 8, wherein said upper plate (V) and said lower plate (P) are provided, on their respective top and bottom, with first pairs of contacts (W1a, W1b; W2a, W2b) that electrically connect identical serving plates placed over or respectively thereunder, and wherein said first pairs of contacts (W1a, W1b) of said lower plate (P) are connected with the recharge connector (Y).

10. The warming tray according to claim 9, further comprising relays (E1, E2) or other equivalent devices adapted to supply the power directly from the recharge connector (Y) or from the pairs of contacts (W1a, W1b) to the on/off switch (O), the thermostat (T) and the heating resistance (R) when the warming tray is connected to electricity mains or is stacked on another warming tray connected to the electricity mains.

11. The warming tray according to the claim 9, further comprising a lid (U) adapted to be placed on and coupled with the upper plate (V) or directly with the upper side (P1a, P1b) of the lower plate (P), wherein said lid (U) is provided with second coupling and connection elements (G3a, G3b) adapted to maintain said lid (U) joined to one or both of said upper plate (V) or said lower plate (P) in a correct position.

12. The warming tray according to claim 11, wherein said lid (U) is provided, on its top and its bottom, with second pairs of contacts (W3a, W3b) for an electric connection with identical serving plates and provided or not provided with a corresponding lid (U).

13. The warming tray according to the preceding claim 12, wherein said pairs of contacts (W1a, W1b; W2a, W2b; W3a, W3b) of said lower plate (P), upper plate (V), and lid (U) are included, built-in, or integrated in one or both of said first and second coupling and connection elements (G1a, G1b; G2a, G2b; G3a, G3b) for connection with identical warming trays placed over or under the warming tray.
